(19) United States
(12) Patent Application Publication
(10) Pub. No.: US 2022/0292967 A1
(43) Pub. Date: Sep. 15, 2022

(54) MOBILE BODY, INFORMATION PROCESSING DEVICE, AND INFORMATION PROCESSING SYSTEM

(71) Applicant: SONY GROUP CORPORATION, TOKYO (JP)

(72) Inventor: HIROSHI KAWASHIMA, TOKYO (JP)

(21) Appl. No.: 17/636,519

(22) PCT Filed: Aug. 17, 2020
(86) PCT No.: PCT/JP2020/030952

§ 371 Date: Feb. 18, 2022

(30) Foreign Application Priority Data
Aug. 29, 2019 (JP) 2019-157071

(51) Int. Cl. G08G 1/123; G08G 1/0967; G01S 17/42; G01S 17/89

(52) U.S. Cl. CPC G08G 1/123; G08G 1/096741; G08G 1/096791; G01S 17/42; G01S 17/89

(57) ABSTRACT

The present technology relates to a mobile body, an information processing device, and an information processing system capable of specifying a mobile body that has transmitted information.

For example, the mobile body such as a vehicle transmits predetermined information by modulation of light emitted by a distance measuring device that emits the light and receives reflected light of the light for performing distance measurement. For example, the information processing device such as a smartphone acquires the predetermined information transmitted by modulation of the light from a light reception signal obtained by reception of the light, and specifies the mobile body including the distance measuring device that has emitted the light including the predetermined information. The present technology can be applied to, for example, an autonomous driving vehicle or the like that performs autonomous driving.

### TECHNICAL FIELD

The present technology relates to a mobile body, an information processing device, and an information processing system, and particularly relates to, for example, a mobile body, an information processing device, and an information processing system capable of specifying a mobile body that has transmitted information.

### BACKGROUND ART

For example, Patent Document 1 discloses a technology in which identification information of a user is displayed on a display device of a vehicle so as to be visible from the outside of the vehicle, and thus a user outside the vehicle can recognize which user has called the vehicle.

### CITATION LIST

### Patent Document

Patent Document 1: Japanese Patent Application Laid-Open No. 2018-097514

### SUMMARY OF THE INVENTION

### Problems to be Solved by the Invention

Meanwhile, in a case where information is transmitted from a mobile body such as a vehicle, it is convenient to specify the mobile body that has transmitted the information.

The present technology has been made in view of such a situation, and makes it possible to specify a mobile body that has transmitted information.

### Solutions to Problems

A mobile body of the present technology is a mobile body including a transmission control unit configured to perform control to transmit predetermined information by modulation of light emitted by a distance measuring device that emits the light and receives reflected light of the light for performing distance measurement.

The mobile body of the present technology transmits the predetermined information by modulation of the light emitted by the distance measuring device that emits the light and receives the reflected light of the light for performing distance measurement.

An information processing device of the present technology is an information processing device including: an information acquisition unit configured to acquire, from a light reception signal obtained by reception of light emitted by a distance measuring device that emits the light and receives reflected light of the light for performing distance measurement, predetermined information transmitted by modulation of the light and including at least identification information for identifying a mobile body including the distance measuring device; and a specification unit configured to specify the mobile body including the distance measuring device that has emitted the light including the predetermined information.

The information processing device of the present technology acquires, from the light reception signal obtained by reception of the light emitted by the distance measuring device that emits the light and receives the reflected light of the light for performing distance measurement, the predetermined information transmitted by modulation of the light and including at least the identification information for identifying the mobile body including the distance measuring device. In addition, the mobile body including the distance measuring device that has emitted the light including the predetermined information is specified.

An information processing system of the present technology is an information processing system including: a mobile body including a transmission control unit configured to perform control to transmit predetermined information by modulation of light emitted by a distance measuring device that emits the light and receives reflected light of the light for performing distance measurement; and an information processing device including an information acquisition unit configured to acquire, from a light reception signal obtained by reception of the light, the predetermined information transmitted by modulation of the light, and a specification unit configured to specify the mobile body including the distance measuring device that has emitted the light including the predetermined information.

In the information processing system of the present technology, the mobile body transmits the predetermined information by modulation of the light emitted by the distance measuring device that emits the light and receives the reflected light of the light for performing distance measurement. The information processing device acquires the predetermined information transmitted by modulation of the light from the light reception signal obtained by reception of the light, and specifies the mobile body including the distance measuring device that has emitted the light including the predetermined information.

Note that the information processing device may be an independent device or an internal block included in one device.

Furthermore, processing in the information processing device or the mobile body can be performed by a computer executing a program. The program can be provided by being recorded on a recording medium or by being transmitted via a transmission medium.

### BRIEF DESCRIPTION OF DRAWINGS

FIG. 1 is a block diagram illustrating a configuration example of an embodiment of a communication system to which the present technology is applied.

FIG. 2 is a block diagram illustrating a configuration example of an embodiment of a vehicle allocation system to which a communication system 1 is applied.

FIG. 3 is a block diagram illustrating a configuration example of an autonomous driving taxi 52.

FIG. 4 is a block diagram illustrating a (functional) configuration example of a smartphone 53.

FIG. 5 is a diagram for describing the principle of distance measurement by a LiDAR 61.

FIG. 6 is a diagram illustrating an external configuration example of the LiDAR 61.

FIG. 7 is a diagram for describing light emitted by the LiDAR 61.

FIG. 8 is a diagram for describing an operation of the LiDAR 61.

FIG. 9 is a diagram for describing an example of transmission control by a transmission control unit 63 that causes the LiDAR 61 to transmit information by modulation of near-infrared light of the LiDAR 61.

FIG. 10 is a diagram for describing an example of processing in a vehicle allocation system 50.

FIG. 11 is a diagram illustrating an example of a display screen displayed on a display unit 78 of the smartphone 53 when a vehicle allocation application is activated.

FIG. 12 is a diagram illustrating an example of a display screen displayed on the display unit 78 when the autonomous driving taxi 52 is assigned to a user who has made a vehicle allocation request.

FIG. 13 is a diagram illustrating an example of a display screen displayed on the display unit 78 when the autonomous driving taxi 52 selected as an assigned taxi moves to a position where the autonomous driving taxi 52 is visible to the user to whom the autonomous driving taxi 52 is assigned.

FIG. 14 is a diagram illustrating an example of a state of a road when the user is waiting for the autonomous driving taxi 52 selected as the assigned taxi.

FIG. 15 is a diagram illustrating a state in which, in response to a proximity message, the user is directing a camera 73 of the smartphone 53 to the autonomous driving taxi 52 in a surrounding visible range to capture an image.

FIG. 16 is a diagram illustrating a display example of an image displayed such that the assigned taxi can be identified.

FIG. 17 is a diagram illustrating a configuration example of a first embodiment of a vehicle control system to which the communication system 1 is applied.

FIG. 18 is a diagram for describing an example of processing in a vehicle control system 110.

FIG. 19 is a diagram illustrating a configuration example of a second embodiment of the vehicle control system to which the communication system 1 is applied.

FIG. 20 is a diagram illustrating a configuration example of a third embodiment of the vehicle control system to which the communication system 1 is applied.

FIG. 21 is a block diagram illustrating a configuration example of an embodiment of a computer to which the present technology is applied.

### MODE FOR CARRYING OUT THE INVENTION

### Embodiment of Communication System to which Present Technology Is Applied

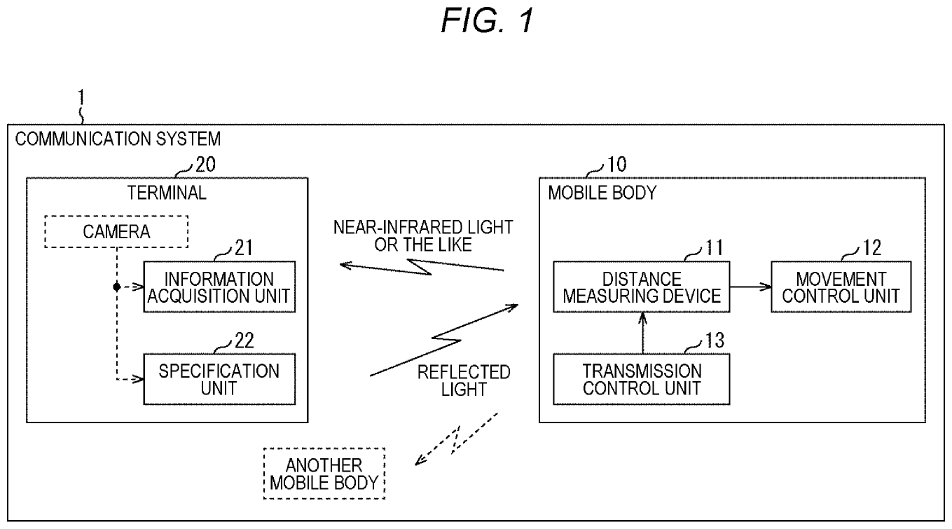

FIG. 1 is a block diagram illustrating a configuration example of an embodiment of a communication system to which the present technology is applied.

In FIG. 1, a communication system 1 includes a mobile body 10 and a terminal 20.

The mobile body 10 is, for example, a vehicle, a flying body, a vessel, a submersible, or another mobile body, and includes a distance measuring device 11, a movement control unit 12, and a transmission control unit 13. Note that the mobile body 10 is not limited to a mobile body on which a person is supposed to ride, and may be, for example, a mobile body on which a person is not supposed to ride, such as a drone.

The distance measuring device 11 performs distance measurement by, for example, emitting light such as near-infrared light having a wavelength of 905 nm or the like and receiving reflected light of the near-infrared light. The distance measuring device 11 supplies distance information obtained by the distance measurement to the movement control unit 12.

Note that the distance measuring device 11 is only required to be a device that can perform distance measurement by emitting light and receiving reflected light of the light, and the type of device and the method of distance measurement are not particularly limited. As the distance measuring device 11, for example, a sensor called light detection and ranging (LiDAR), a sensor called time of flight (TOF), a sensor adopted in Kinect of Microsoft Corporation, or the like can be adopted.

As the method of distance measurement, for example, a TOF method, a triangulation method, a frequency modulated continuous wave (FMCW) method, a method of emitting light of a predetermined pattern and receiving reflected light of the light, or any method of emitting other light and receiving reflected light of the light can be adopted.

Furthermore, in the distance measuring device 11, the light used for distance measurement is not limited to near-infrared light, and mid-infrared light (infrared ray), far-infrared light, visible light, ultraviolet light, or any other light can be adopted. However, for example, if near-infrared light, which is light other than visible light, is adopted as the light used for distance measurement by the distance measuring device 11, it is possible to prevent a person from visually recognizing the light of the distance measuring device 11.

Furthermore, for example, in a case where the terminal 20 includes a camera, the terminal 20 can receive near-infrared light as the light emitted by the distance measuring device 11 with an imaging element of the camera without being separately provided with a dedicated sensor for receiving the light emitted by the distance measuring device 11. The imaging element is, for example, a CMOS image sensor, a CCD image sensor, or the like, but is not limited thereto, and any imaging element can be used as long as light can be converted into an electric signal.

The movement control unit 12 controls the movement of the mobile body 10 according to the distance information from the distance measuring device 11. For example, the movement control unit 12 controls the movement of the mobile body 10 to perform autonomous driving in which the mobile body 10 moves while avoiding an obstacle.

The transmission control unit 13 controls the distance measuring device 11 to include predetermined information in near-infrared light and transmit the near-infrared light. That is, the transmission control unit 13 performs transmission control to cause the distance measuring device 11 to transmit the predetermined information by modulation of the near-infrared light emitted by the distance measuring device 11. As a modulation method of near-infrared light, for example, amplitude modulation, frequency modulation, or the like can be adopted.

The terminal 20 is, for example, a portable information processing device that can be carried by a user, such as a smartphone, and includes an information acquisition unit 21 and a specification unit 22.

The information acquisition unit 21 acquires the predetermined information included in the near-infrared light emitted by the distance measuring device 11 included in the mobile body 10. That is, the information acquisition unit 21 demodulates a light reception signal obtained by receiving the near-infrared light from (the distance measuring device 11 included in) the mobile body 10, and acquires the predetermined information transmitted by modulation of the near-infrared light from the demodulated light reception signal.

The reception of the near-infrared light in the information acquisition unit 21 can be performed by an imaging element of a camera that captures an image, which is equipped in a smartphone as the terminal 20. That is, in a case where the user directs the camera of the smartphone in the direction of (the distance measuring device 11 of) the mobile body 10, the imaging element of the camera of the smartphone as the terminal 20 can receive the near-infrared light emitted by the distance measuring device 11 of the mobile body 10. Note that, in the terminal 20, not the imaging element of the camera but a dedicated light receiving element may receive the light emitted by the distance measuring device 11 included in the mobile body 10.

The specification unit 22 uses the orientation of the smartphone as the terminal 20 at the time of receiving the near-infrared light or an image captured by the camera (which may include an image of the near-infrared light) to specify the mobile body 10 (including the distance measuring device 11) that has emitted the near-infrared light including the predetermined information from among subjects shown in the image captured by the camera, using the straightness (directivity) of light (near-infrared light). In the process of specifying the mobile body 10 that has emitted the near-infrared light including the predetermined information, it is possible to detect the direction of the mobile body 10 that has emitted the near-infrared light including the predetermined information as necessary.

According to the communication system 1 in FIG. 1, even if there is no communication means dedicated to communication, the mobile body 10 can transmit the predetermined information by the near-infrared light emitted by the distance measuring device 11. Furthermore, even if there is no communication means dedicated to communication, the terminal 20 can receive (acquire) the predetermined information from the mobile body 10 by the imaging element of the camera receiving the near-infrared light. Moreover, the terminal 20 can specify the mobile body 10 that has transmitted the predetermined information, that is, the mobile body 10 that has emitted the light including the predetermined information.

Note that, in addition to the terminal 20, another mobile body configured similarly to the mobile body 10 can have functions similar to those of the information acquisition unit 21 and the specification unit 22, acquire information included in near-infrared light and transmitted from the mobile body 10, and specify the mobile body 10 that has transmitted the information. In this case, providing the mobile body 10 with the functions similar to those of the information acquisition unit 21 and the specification unit 22 enables the mobile body 10 to acquire information included in near-infrared light and transmitted from the another mobile body and specify the another mobile body that has transmitted the information. Therefore, even if there is no communication means dedicated to communication, it is possible to exchange information between the mobile body 10 and the another mobile body and specify a communication partner that has transmitted the information.

### Embodiment of Vehicle Allocation System to which Communication System Is Applied

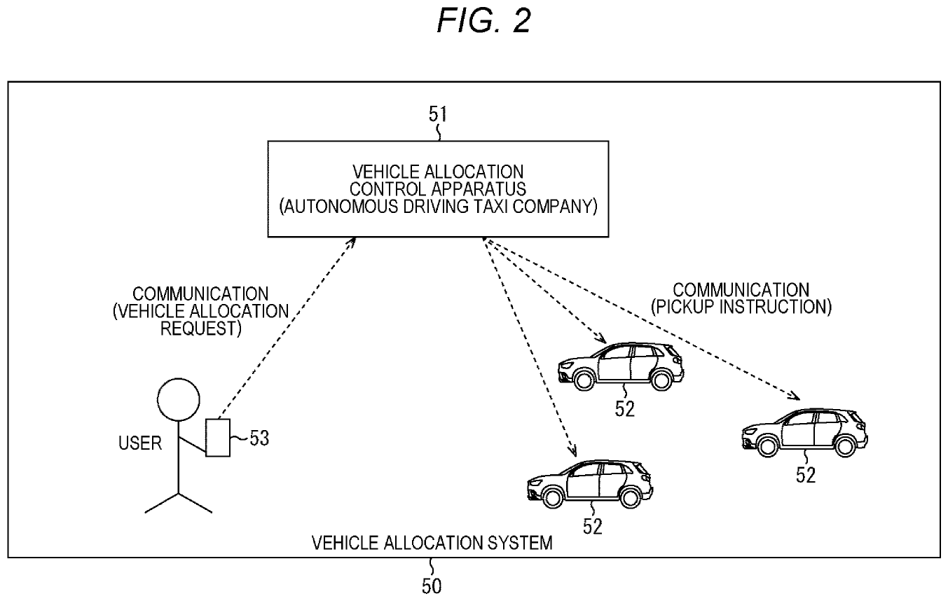

FIG. 2 is a block diagram illustrating a configuration example of an embodiment of a vehicle allocation system to which the communication system 1 in FIG. 1 is applied.

In FIG. 2, a vehicle allocation system 50 includes a vehicle allocation control apparatus 51, one or more autonomous driving taxis 52, and a smartphone 53.

The vehicle allocation control apparatus 51 is managed by an autonomous driving taxi company that provides a taxi service using the autonomous driving taxis 52. When the smartphone 53 of a user transmits a vehicle allocation request for requesting vehicle allocation by wireless communication such as long term evolution (LTE) or a wireless local area network (LAN), for example, the vehicle allocation control apparatus 51 controls pickup of the user by one of the autonomous driving taxis 52 in response to the vehicle allocation request.

That is, for example, the vehicle allocation control apparatus 51 selects the autonomous driving taxi 52 that picks up the user according to the distance or the like between the user and each of the autonomous driving taxis 52, and transmits a pickup instruction for instructing the selected autonomous driving taxi 52 to pick up the user to the autonomous driving taxi 52 by wireless communication.

Each of the autonomous driving taxi 52 corresponds to the mobile body 10 in FIG. 1. In response to the pickup instruction from the vehicle allocation control apparatus 51, the autonomous driving taxi 52 provides a so-called taxi service in which the autonomous driving taxi 52 picks up the user, allows the user to ride, and moves (travels) to a destination of the user by autonomous driving.

The smartphone 53 corresponds to the terminal 20 in FIG. 1. An application for vehicle allocation (vehicle allocation application) is installed in the smartphone 53, and the smartphone 53 executes the vehicle allocation application. The smartphone 53 executing the vehicle allocation application transmits the vehicle allocation request to the vehicle allocation control apparatus 51 by wireless communication, for example, according to an operation of the user.

### Configuration Example of Autonomous Driving Taxi 52

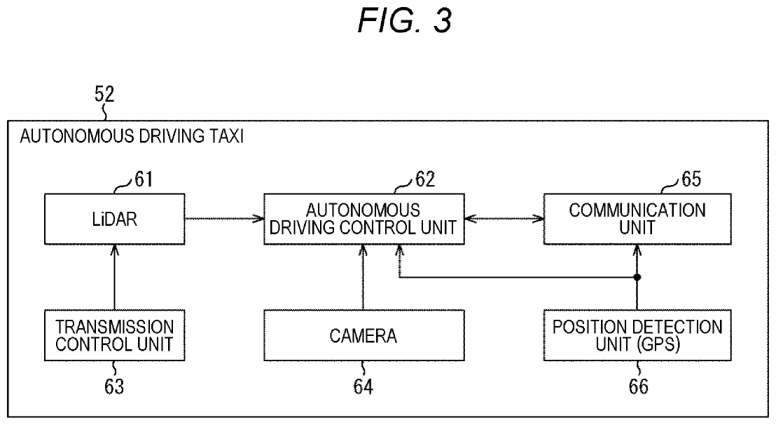

FIG. 3 is a block diagram illustrating a configuration example of the autonomous driving taxi 52.

The autonomous driving taxi 52 includes a LiDAR 51, an autonomous driving control unit 62, a transmission control unit 63, a camera 54, a communication unit 65, and a position detection unit 66.

The LiDAR 61 corresponds to the distance measuring device 11 in FIG. 1, and is attached to, for example, a portion of the autonomous driving taxi 52 with good visibility, such as a roof. The LiDAR 61 performs distance measurement by emitting near-infrared light having a wavelength of about 905 nm and receiving reflected light of the near-infrared light. The LiDAR 61 supplies distance information obtained by the distance measurement to the autonomous driving control unit 62.

The autonomous driving control unit 62 corresponds to the movement control unit 12 in FIG. 1. The autonomous driving control unit 62 recognizes a surrounding state and calculates a moving route from a current location to a destination, for example, according to the distance information from the LiDAR 61, an image of 64 from the camera, the position of the autonomous driving taxi 52 from the position detection unit 66, information supplied from the communication unit 65, and the like, thereby controlling the movement of the autonomous driving taxi 52. The autonomous driving control unit 62 controls the movement of the autonomous driving taxi 52, so that the autonomous driving of the autonomous driving taxi 52 is performed.

The transmission control unit 63 corresponds to the transmission control unit 13 in FIG. 1. The transmission control unit 63 controls the LiDAR 61 to include, in near-infrared light, an ID (identification information) for identifying the autonomous driving taxi 52 (hereinafter, the ID will also be referred to as a taxi ID), which corresponds to the predetermined information, and transmit the near-infrared light. That is, the transmission control unit 63 performs transmission control to cause the LiDAR 61 to transmit the taxi ID by modulation of the near-infrared light emitted by the LiDAR 61.

The camera 64 captures an image of the surroundings of the autonomous driving taxi 52 and supplies the captured image to the autonomous driving control unit 62.

The position detection unit 66 is, for example, a global positioning system (GPS) or the like, detects the position (current location) of the autonomous driving taxi 52, and supplies the detected position to the autonomous driving control unit 62 and the communication unit 65.

The communication unit 65 performs wireless communication with the vehicle allocation control apparatus 51 (FIG. 2) and the like to transmit and receive information. For example, the communication unit 65 transmits the position of the autonomous driving taxi 52 from the position detection unit 66 and the like to the vehicle allocation control apparatus 51. Furthermore, for example, the communication unit 65 receives the pickup instruction or the like from the vehicle allocation control apparatus 51, and supplies the pickup instruction or the like to the autonomous driving control unit 62.

### Configuration Example of Smartphone 53

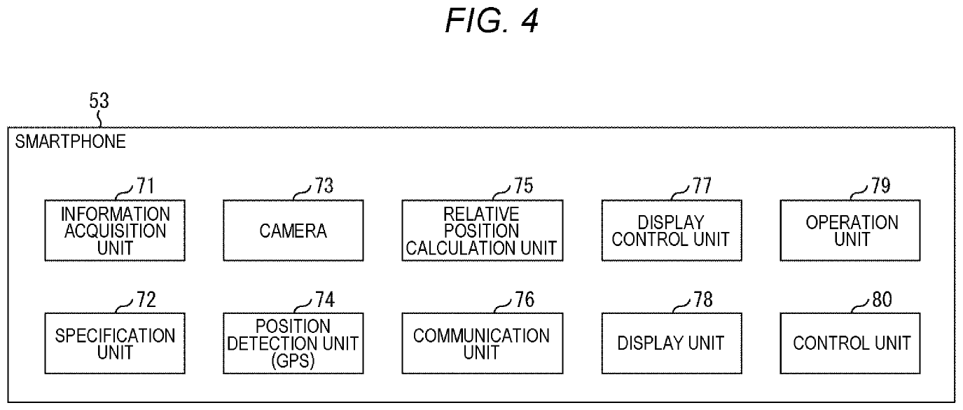

FIG. 4 is a block diagram illustrating a (functional) configuration example of the smartphone 53.

The smartphone 53 includes an information acquisition unit 71, a specification unit 72, a camera 73, a position detection unit 74, a relative position calculation unit 75, a communication unit 76, a display control unit 77, a display unit 78, an operation unit 79, and a control unit 80.

The information acquisition unit 71 corresponds to the information acquisition unit 21 in FIG. 1. The information acquisition unit 71 demodulates a light reception signal obtained by receiving the near-infrared light from (the LiDAR 61 of) the autonomous driving taxi 52 as a result of capturing an image with the camera 73, thereby acquiring the taxi ID included in the near-infrared light.

The specification unit 72 corresponds to the specification unit 22 in FIG. 1. The specification unit 72 uses the image captured by the camera 73 and showing near-infrared light to specify the autonomous driving taxi 52 that has emitted the near-infrared light including a predetermined taxi ID from among subjects shown in the image.

The camera (image capturing unit) 73 captures an image, that is, receives incident light and performs photoelectric conversion.

The position detection unit 74 is, for example, a GPS or the like, and detects the position (current location) of the smartphone 53.

The relative position calculation unit 75 calculates the relative position of the autonomous driving taxi 52 with respect to the smartphone 53 from the image captured by the camera 73 and showing the autonomous driving taxi 52.

The communication unit 76 performs wireless communication with the vehicle allocation control apparatus 51 (FIG. 2) and the like to transmit and receive information.

The display control unit 77 performs display control to cause the display unit 78 to display an image.

The display unit 78 includes, for example, a liquid crystal panel or the like, and displays an image according to the display control by the display control unit 77.

The operation unit 79 outputs operation information corresponding to an operation of the user. As the operation unit 79, for example, a transparent touch panel can be adopted. In this case, the operation unit 79 can be integrally configured with the display unit 78.

The control unit 80 controls each block included in the smartphone 53, for example.

### LiDAR61

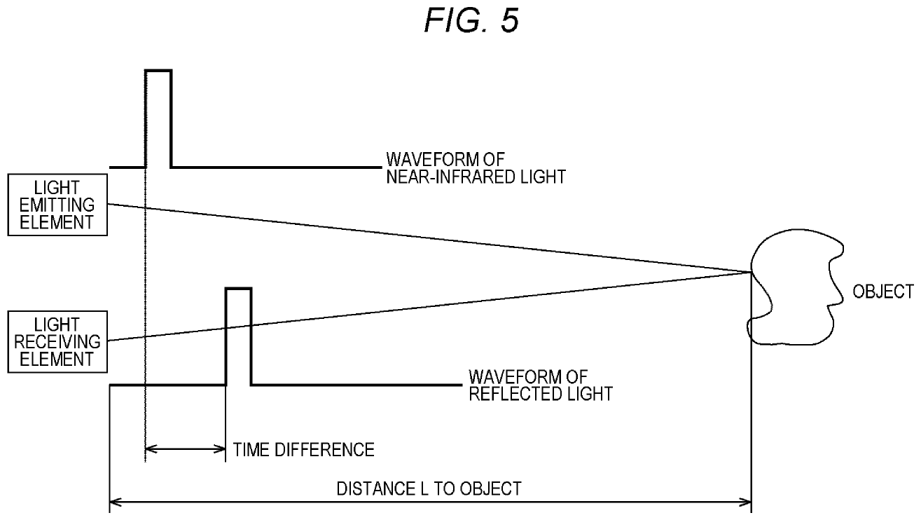

FIG. 5 is a diagram for describing the principle of distance measurement of the LiDAR 61 in FIG. 3.

In the LiDAR 61, near-infrared light is emitted from a light emitting element, and reflected light as the near-infrared light returning after being reflected by an object is received by a light receiving element.

The time from the emission of the near-infrared light to the reception of the reflected light is proportional to the distance from (the light emitting element and the light receiving element of) the LiDAR 61 to the object. Therefore, the LiDAR 61 detects the time (time difference) from the emission of the near-infrared light to the reception of the reflected light, and obtains the distance to the object on the basis of the time.

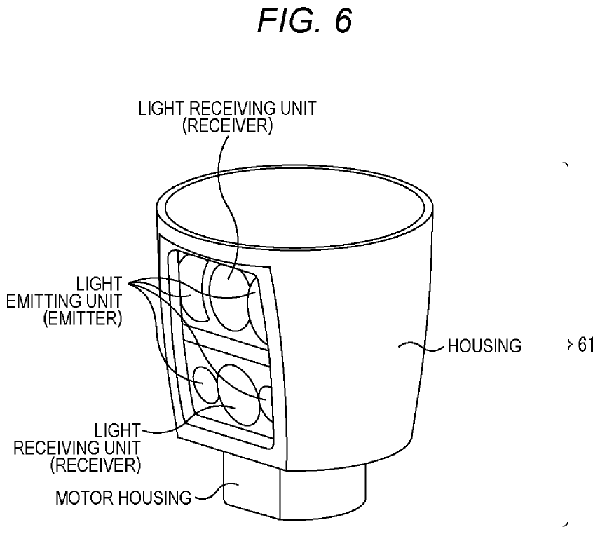

FIG. 6 is a diagram illustrating an external configuration example of the LiDAR 61.

In FIG. 6, as the LiDAR 61, a three dimensional 360-degree rotary LiDAR is adopted.

The LiDAR 61 is configured such that a light emitting unit (emitter) including the light emitting element and a light receiving unit (receiver) including the light receiving element are housed in a housing. The housing including the light emitting unit and the light receiving unit is rotated by a motor (not illustrated) whose rotation axis is in the vertical direction. The motor is housed in a motor housing.

In the LiDAR 61 in FIG. 6, the housing is rotated so that the distance measurement is performed in a direction in a 360-degree range surrounding the LiDAR 61.

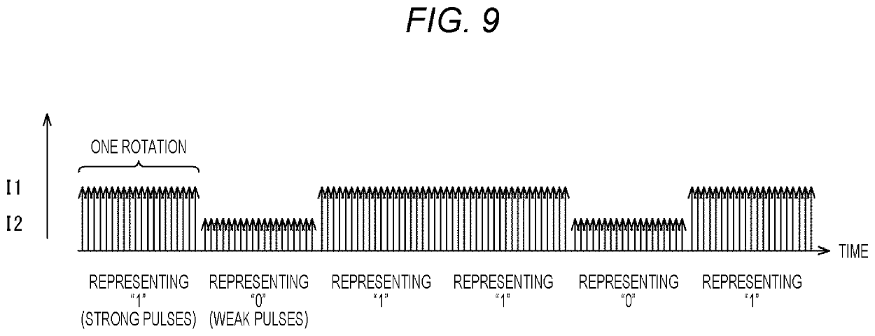

Note that, as the LiDAR 61, a scanning LiDAR using a repetitive oscillation pulse laser and a scanner, a flash LiDAR using a high-power single pulse oscillation laser and a time-resolved two-dimensional light receiving element array, a hybrid LiDAR in which a scanner is used in one direction and a one-dimensional light receiving element array is used in a direction perpendicular to the direction of the scanner to collectively receive light, or the like can be used. In addition, as a scanning method, a method using a mechanical rotation mechanism as illustrated in FIG. 9, a method using a MEMS mechanism, a method called a phased array, or the like can be used, and any other LiDAR can be adopted.

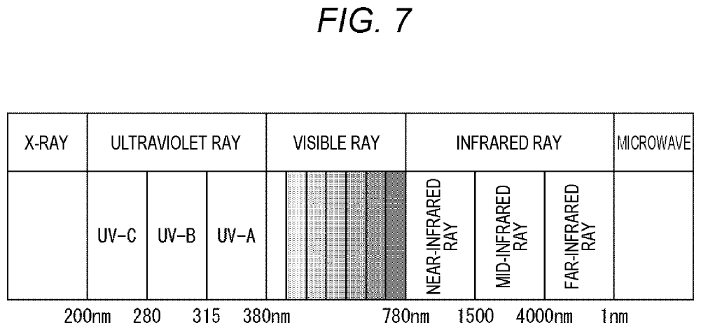

FIG. 7 is a diagram illustrating the light emitted by the LiDAR 61.

The LiDAR 61 emits near-infrared light (near-infrared ray) having a wavelength close to visible light, for example, a wavelength of about 900 nm to 1600 nm. Near-infrared light cannot be visually recognized by a person, but can be captured by an imaging element of a general camera that captures (receives) visible light. Therefore, if there is a camera, it is possible to receive near-infrared light without preparing a dedicated light receiving element.

Note that the light emitted by the LiDAR 61 is not limited to near-infrared light, and may be other light that cannot be visually recognized by a person, for example, mid-infrared light (mid-infrared ray) or far-infrared light (far-infrared ray).

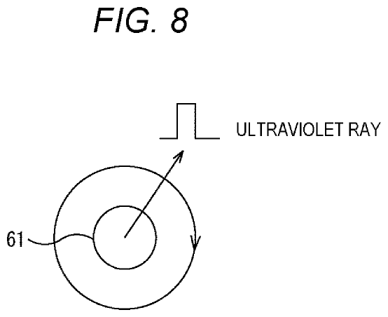

FIG. 8 is a diagram for describing an operation of the LiDAR 61.

FIG. 8 is a top view of the three-dimensional 360-degree rotary LiDAR 61 in FIG. 6, as viewed from above.

The LiDAR 61 (housing thereof) emits near-infrared light pulses while rotating around the rotation axis in the direction perpendicular to the drawing. The rotation speed of the LiDAR 61 is, for example, 5 to 20 rotations/second, and the number of near-infrared light pulses (the number of light emissions) per rotation is about 4000 to 1100 pulses.

FIG. 9 is a diagram for describing an example of the transmission control by the transmission control unit 63 that causes the LiDAR 61 to transmit information by modulation of the near-infrared light of the LiDAR 61.

FIG. 9 illustrates an example of the near-infrared light pulses emitted by the LiDAR 61.

The transmission control unit 63 (FIG. 3) causes the LiDAR 61 to perform amplitude modulation of near-infrared light according to information to be included in the near-infrared light and transmitted, thereby transmitting the information.

As the amplitude modulation of near-infrared light, for example, amplitude modulation can be performed in which the intensity of the near-infrared light pulses (indicated by arrows) is set to (strong) intensity I1 for information 1 and is set to intensity I2, which is weaker than the intensity I1, for information 0, as illustrated in FIG. 9. The amplitude modulation can be performed once per rotation of the LiDAR 61.

In FIG. 9, 6-bit information 101101 is transmitted.

In a case where the rotation speed of the LiDAR 61 is, for example, 5 to 20 rotations/second as described with reference to FIG. 8, information can be transmitted at a rate of 5 to 20 bits/second when the amplitude modulation is performed once per rotation of the LiDAR 61.

Note that the amplitude modulation can be performed once per two or more rotations of the LiDAR 61 in addition to once per rotation, and the number of rotations is an integer. Furthermore, as the amplitude modulation of near-infrared light, amplitude modulation can be adopted in which the intensity of the near-infrared light is set to a value that is a power of two and is equal to or larger than four in addition to the binary values of the intensities I1 and I2.

### Processing in Vehicle Allocation System 50

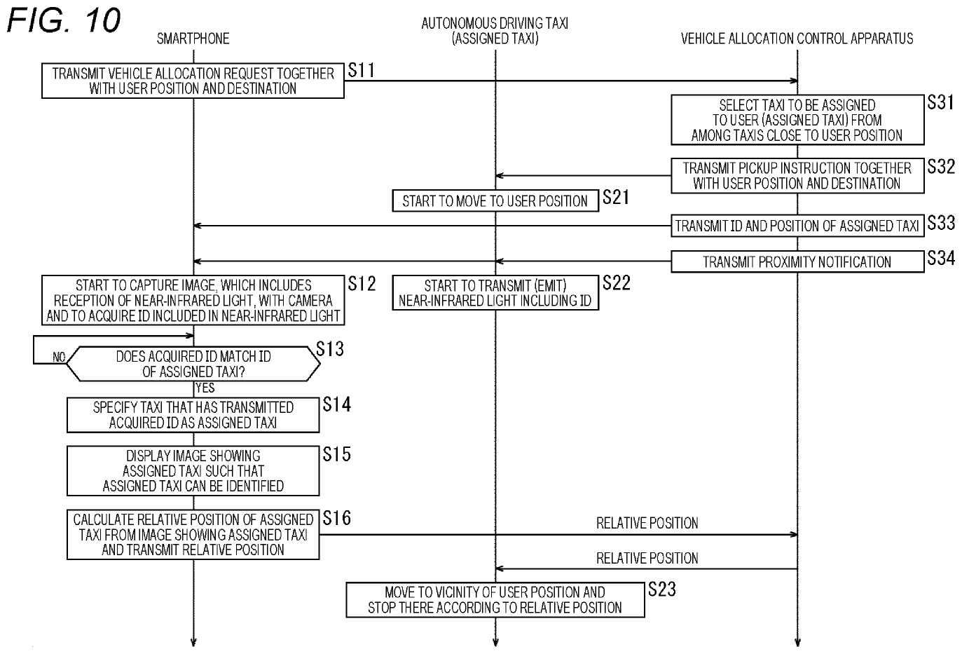

FIG. 10 is a diagram illustrating an example of processing in the vehicle allocation system 50 in FIG. 2.

When a user operates the operation unit 79 of the smartphone 53 (FIG. 4) to input a destination (destination) and make a vehicle allocation request, in step S11, the communication unit 76 of the smartphone 53 transmits the vehicle allocation request, the destination, and the position of (the user carrying) the smartphone 53 (hereinafter, the position will also be referred to as a user position) detected by the position detection unit 74 to the vehicle allocation control apparatus 51 (FIG. 2) in response to the vehicle allocation request made by the user.

The vehicle allocation control apparatus 51 receives the vehicle allocation request, the destination, and the user position from the smartphone 53. In step S31, in response to the vehicle allocation request from the smartphone 53, the vehicle allocation control apparatus 51 selects, as an assigned taxi, an autonomous driving taxi 52 to be assigned to the user from among autonomous driving taxis 52 close to the user position.

Furthermore, in step S32, the vehicle allocation control apparatus 51 transmits the user position and the destination together with a pickup instruction to the autonomous driving taxi 52 selected as the assigned taxi.

In the autonomous driving taxi 52 (FIG. 3) selected as the assigned taxi, the communication unit 65 receives the pickup instruction, the user position, and the destination from the vehicle allocation control apparatus 51. In the autonomous driving taxi 52 selected as the assigned taxi, in step S21, the autonomous driving control unit 62 performs control to move the autonomous driving taxi 52 to the user position in response to the pickup instruction from the vehicle allocation control apparatus 51. As a result, the autonomous driving taxi 52 selected as the assigned taxi starts to move to the user position by autonomous driving.

In step S33, the vehicle allocation control apparatus 51 transmits the taxi ID and the taxi position of the autonomous driving taxi 52 selected as the assigned taxi to the smartphone 53 that has transmitted the vehicle allocation request.

That is, the vehicle allocation control apparatus 51 constantly collects the positions of the autonomous driving taxis 52 (hereinafter, the positions will also be referred to as taxi positions) detected by the position detection units 66 of the autonomous driving taxis 52 (FIG. 3). In step S33, the vehicle allocation control apparatus 51 transmits, to the smartphone 53, the taxi ID of the autonomous driving taxi 52 selected as the assigned taxi and the taxi position of the autonomous driving taxi 52.

The vehicle allocation control apparatus 51 can appropriately transmit the taxi position of the autonomous driving taxi 52 selected as the assigned taxi to the smartphone 53.

In the smartphone 53, the communication unit 76 receives the taxi ID and the taxi position of the assigned taxi from the vehicle allocation control apparatus 51. In the smartphone 53, the display control unit 77 can display a map on the display unit 78, and further display the taxi position of the autonomous driving taxi 52 selected as the assigned taxi on the map. In this case, the user carrying the smartphone 53 can recognize the taxi position of the autonomous driving taxi 52 selected as the assigned taxi.

According to the user position from the smartphone 53 and the taxi position of the autonomous driving taxi 52 selected as the assigned taxi, the vehicle allocation control apparatus 51 monitors whether or not the autonomous driving taxi 52 selected as the assigned taxi has moved to a position where the autonomous driving taxi 52 is visible to the user to whom the autonomous driving taxi 52 is assigned (hereinafter, the user will also be referred to as an assigned user).

Furthermore, when the autonomous driving taxi 52 selected as the assigned taxi moves to the position where the autonomous driving taxi 52 is visible to the assigned user, in step S34, the vehicle allocation control apparatus 51 transmits, to the autonomous driving taxi 52 selected as the assigned taxi and the smartphone 53 of the assigned user, a proximity notification for indicating that the autonomous driving taxi 52 has moved to the position where the autonomous driving taxi 52 is visible to the assigned user.

The communication unit 65 of the autonomous driving taxi 52 selected as the assigned taxi and the communication unit 76 of the smartphone 53 of the assigned user receive the proximity notification from the vehicle allocation control apparatus 51.

In the autonomous driving taxi 52 selected as the assigned taxi, in step S22, the transmission control unit 63 starts to include the taxi ID of the autonomous driving taxi 52 selected as the assigned taxi in near-infrared light emitted by the LiDAR 61 and transmit the near-infrared light in response to the proximity notification from the vehicle allocation control apparatus 51.

In the smartphone 53 of the assigned user, the display control unit 77 displays, on the display unit 78, a message indicating that the assigned taxi is nearby or a message prompting the assigned user to capture an image of the assigned taxi in response to the proximity notification from the vehicle allocation control apparatus 51.

In response to the message displayed on the display unit 78, the assigned user directs the camera 73 of the smartphone 53 to an autonomous driving taxi 52 in a surrounding visible range.

In step S12, in the smartphone 53, the camera 73 starts to capture an image, which includes reception of near-infrared light emitted by the LiDAR 61 of the autonomous driving taxi 52. Furthermore, in the smartphone 53, the information acquisition unit 71 starts to acquire the taxi ID included in the near-infrared light received by the imaging element of the camera 73.

Thereafter, in the smartphone 53, in step S13, the control unit 80 determines whether or not the taxi ID acquired by the information acquisition unit 71 (hereinafter, the taxi ID will also be referred to as an acquired ID) matches the taxi ID of the autonomous driving taxi 52 selected as the assigned taxi, which has been transmitted from the vehicle allocation control apparatus 51 in step S33.

In a case where it is determined in step S13 that the acquired ID does not match the taxi ID of the autonomous driving taxi 52 selected as the assigned taxi, the processing returns to step S13.

Furthermore, in a case where it is determined in step S13 that the acquired ID matches the taxi ID of the autonomous driving taxi 52 selected as the assigned taxi, the processing proceeds to step S14.

In step S14, the specification unit 72 of the smartphone 53 specifies the autonomous driving taxi 52 that has transmitted the near-infrared light including the acquired ID matching the taxi ID (specific identification information) of the autonomous driving taxi 52 selected as the assignment from among subjects shown in the image captured by the camera 73 on the basis of the light emission position of the near-infrared light, and recognizes the autonomous driving taxi 52 as the assigned taxi.

Furthermore, in the smartphone 53, in step S15, the display control unit 77 displays, on the display unit 78, the image captured by the camera 64 and showing the autonomous driving taxi 52 selected as the assigned taxi such that the user can visually identify the assigned taxi.

For example, in the image captured by the camera 64 and showing the autonomous driving taxi 52 selected as the assigned taxi, the autonomous driving taxi 52 selected as the assigned taxi is displayed surrounded by a frame.

The assigned user can easily recognize (the autonomous driving taxi 52 selected as) the assigned taxi by viewing the image displayed on the display unit 78.

In the smartphone 53, in step S16, the relative position calculation unit 75 calculates the relative position of the autonomous driving taxi 52 as the assigned taxi with respect to the smartphone 53 (the relative position of the smartphone 53 with respect to the autonomous driving taxi 52 as the assigned taxi) by using the image captured by the camera 73 and showing the autonomous driving taxi 52 selected as the assigned taxi. Furthermore, the communication unit 76 transmits the relative position to the autonomous driving taxi 52 selected as the assigned taxi via the vehicle allocation control apparatus 51.

In the autonomous driving taxi 52 selected as the assigned taxi, the communication unit 65 receives the relative position from the smartphone 53. Then, in step S23, the autonomous driving control unit 62 moves the autonomous driving taxi 52 selected as the assigned taxi to the vicinity of the user position and stops (stops) the autonomous driving taxi 52 there according to the relative position.

The relative position obtained from the image captured by the camera 73 is more accurate than the position obtained by the GPS, and according to such a highly accurate relative position, the autonomous driving taxi 52 selected as the assigned taxi can stop, for example, at a position in front of the user, which is extremely close to the user, similarly to a manned taxi.

The autonomous driving taxi 52 selected as the assigned taxi, which has stopped in the vicinity of the user position, then allows the assigned user to ride and moves to the destination transmitted from the vehicle allocation control apparatus 51.

As described above, the autonomous driving taxi 52 transmits the taxi ID by modulation of the near-infrared light of the LiDAR 61. Meanwhile, the smartphone 53 receives the near-infrared light and acquires the taxi ID transmitted by modulation of the near-infrared light. Furthermore, the smartphone 53 specifies the autonomous driving taxi 52 that has transmitted the near-infrared light including the taxi ID of the assigned taxi from the image showing the near-infrared light, and recognizes the autonomous driving taxi 52 as the assigned taxi. Furthermore, the image showing the assigned taxi is displayed such that the assigned taxi can be identified.

Therefore, the user can easily recognize the assigned taxi.

Here, regarding a pickup by an autonomous driving taxi, a user may have difficulty in understanding which autonomous driving taxi is an assigned taxi assigned to the user. In particular, for example, in a case where a plurality of users is waiting for autonomous driving taxis as pickup cars at a close position, or in a case where a plurality of autonomous driving taxis each having a similar external configuration is approaching the user, it is difficult to understand the correspondence between the user and the autonomous driving taxi assigned to the user.

Furthermore, when an autonomous driving taxi picks up a user, the positions of the user and the autonomous driving taxi are acquired by, for example, a GPS built in a smartphone carried by the user, a GPS equipped in the autonomous driving taxi, and the like, so that the autonomous driving taxi can be navigated to a position at a certain distance from the user. When the autonomous driving taxi picks up the user, it is desired to stop the autonomous driving taxi as close as possible to the user to whom the autonomous driving taxi is assigned, but it is difficult to bring the autonomous driving taxi as close as possible to the user with the accuracy of the positions detected by the GPSs.

In a manned taxi, a driver guesses the user who has requested the pickup and confirms the name of the user verbally, so that it is possible to easily understand the correspondence between the user who has requested the pickup and the taxi. However, when the autonomous driving taxi picks up the user, it is difficult to perform a process similar to that in the manned taxi.

Furthermore, a method is conceivable in which an image of the face of a user is registered and face recognition is performed in an autonomous driving taxi to recognize the user to whom the autonomous driving taxi is assigned. However, in this method, it is necessary to register the image of the face of the user, and the user is reluctant to register the image of the face because the image of the face is personal information of the user.

Furthermore, as a taxi allocation application, there is a vehicle allocation application that displays appearance characteristics (vehicle type, color, and the like) of a manned taxi that picks up a user so that it is easy for the user to recognize the taxi for pickup. However, when the autonomous driving taxi becomes widespread, it is expected that the number of autonomous driving taxis of the same vehicle type will increase. Therefore, in a case where there is a plurality of autonomous driving taxis of the same vehicle type around the user, it is difficult to recognize which autonomous driving taxi is an assigned taxi assigned to the user even if the vehicle allocation application displays appearance characteristics of the autonomous driving taxi that picks up the user.

In addition, there is a pickup method in which a user notifies a vehicle of a standby position and the vehicle moves to the standby position of the user. However, in this method, it is difficult for the user to recognize the vehicle that picks up the user. Furthermore, it is also difficult to accurately identify the positions of the user and the vehicle.

In the technology described in Patent Document 1 (Japanese Patent Application Laid-Open No. 2018-097514), identification information of a user is displayed on a display device of a vehicle so as to be visible from the outside of the vehicle. In this case, the user needs to memorize the identification information, and further, the display device needs to be provided at a position where the user can visually recognize the identification information.

Furthermore, for example, a method is conceivable in which a smartphone carried by a user receives a radio wave used by an autonomous driving taxi for wireless communication and detects the direction of the autonomous driving taxi as the transmission source of the radio wave. However, since the directivity of the radio wave is weak, it is difficult for the smartphone that has received the radio wave to accurately detect the direction of the autonomous driving taxi as the transmission source of the radio wave. Furthermore, it is also difficult to determine the relative position of the autonomous driving taxi with respect to the smartphone.

Meanwhile, since the directivity of light such as near-infrared light is very strong, receiving light makes it possible to accurately detect the direction of the light emitting source of the light.

An autonomous driving vehicle that performs autonomous driving, which is essential for realizing mobility as a service (MaaS) at a high level, is equipped with a LiDAR that performs distance measurement by use of near-infrared light. Therefore, transmitting information by modulation of the near-infrared light emitted by the LiDAR equipped in the autonomous driving vehicle makes it possible to transmit the information by light at a lower cost than in a case where a device that transmits the information by light is separately provided. Furthermore, on the light receiving side that receives the light, using the directivity (straightness) of light makes it possible to easily detect the direction of the light emitting source of the light.

Furthermore, in a case where near-infrared light is used as light for transmitting information, the near-infrared light can be captured (received) by an imaging element of a general camera. Therefore, in a case where information is included in the near-infrared light emitted by the LiDAR and the near-infrared light is transmitted, for example, a smartphone can receive the near-infrared light with the imaging element of the camera included in the smartphone and acquire the information included in the infrared light without being provided with a dedicated light receiving element that receives near-infrared light.

Hereinafter, the processing in the vehicle allocation system 50 in FIG. 2 will be further described.

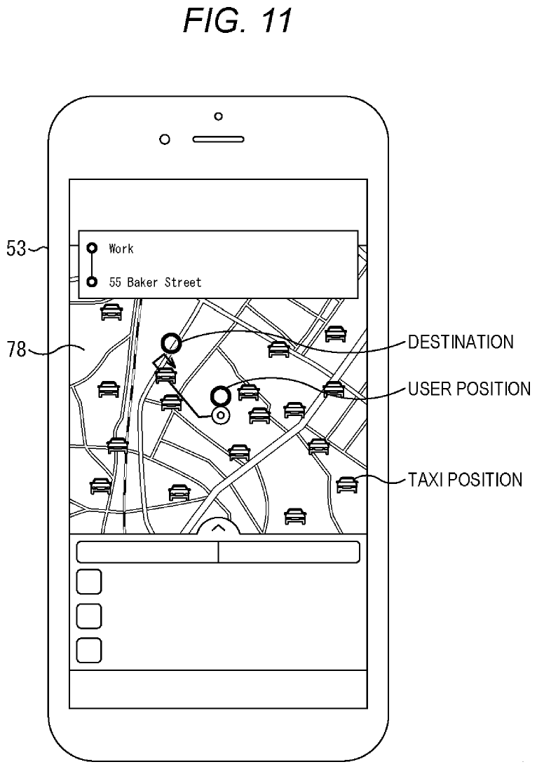

FIG. 11 is a diagram illustrating an example of a display screen displayed on the display unit 78 of the smartphone 53 when the vehicle allocation application is activated.

The display control unit 77 causes the display unit 78 to display the map of the surrounding area including the user position together with (an image representing) the user position according to the user position detected by the position detection unit 74. The user operates the operation unit 79 to input the destination and make the vehicle allocation request. The display control unit 77 causes (an image representing) the destination to be displayed on the map on the display unit 78 according to the destination input by the user. In response to the vehicle allocation request, the communication unit 76 transmits, to the vehicle allocation control apparatus 51 (FIG. 2), the user position and the destination together with the vehicle allocation request. Note that the display control unit 77 can further cause (an image representing) the taxi positions of the autonomous driving taxis 52 to be displayed on the map on the display unit 78. The taxi positions can be obtained from the vehicle allocation control apparatus 51.

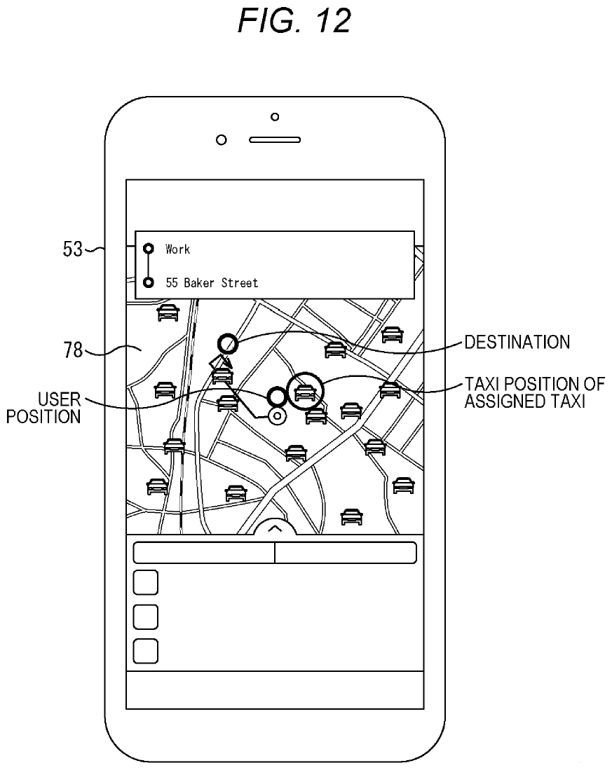

FIG. 12 is a diagram illustrating an example of a display screen displayed on the display unit 78 when the autonomous driving taxi 52 is assigned to the user who has made the vehicle allocation request.

The vehicle allocation control apparatus 51 receives the vehicle allocation request, the user position, and the destination from the smartphone 53, and selects, as the assigned taxi, the autonomous driving taxi 52 to be assigned to the user from among the autonomous driving taxis 52 close to the user position in response to the vehicle allocation request. Moreover, the vehicle allocation control apparatus 51 transmits the taxi ID and the taxi position of the assigned taxi to the smartphone 53 that has transmitted the vehicle allocation request.

In the smartphone 53, the communication unit 76 receives the taxi ID and the taxi position of the assigned taxi from the vehicle allocation control apparatus 51. The display control unit 77 then causes the taxi position of the assigned taxi to be displayed on the map on the display unit 78. As a result, the user who has made the vehicle allocation request can recognize the taxi position of the assigned taxi.

Note that, in response to the vehicle allocation request from the smartphone 53, the vehicle allocation control apparatus 51 transmits the user position and the destination together with the pickup instruction to the autonomous driving taxi 52 selected as the assigned taxi.

In the autonomous driving taxi 52 selected as the assigned taxi, the communication unit 65 receives the pickup instruction, the user position, and the destination from the vehicle allocation control apparatus 51. In response to the pickup instruction from the vehicle allocation control apparatus 51, the autonomous driving control unit 62 performs control to move the autonomous driving taxi 52 to the user position.

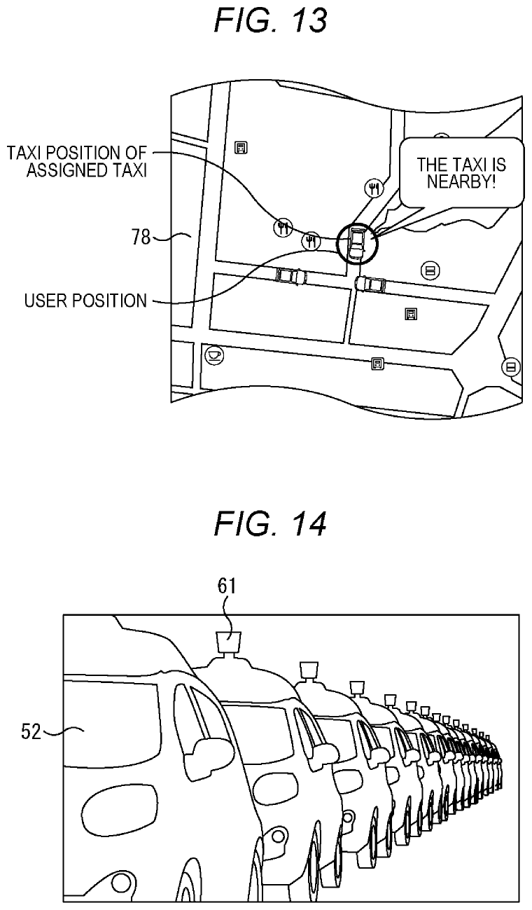

FIG. 13 is a diagram illustrating an example of a display screen displayed on the display unit 78 when the autonomous driving taxi 52 selected as the assigned taxi moves to the position where the autonomous driving taxi 52 is visible to the assigned user.

The vehicle allocation control apparatus 51 constantly collects the taxi positions of the autonomous driving taxis 52. When the autonomous driving taxi 52 selected as the assigned taxi moves to the position where the autonomous driving taxi 52 is visible to the assigned user to whom the autonomous driving taxi 52 is assigned, the vehicle allocation control apparatus 51 transmits the proximity notification for indicating the effect to the autonomous driving taxi 52 selected as the assigned taxi and the smartphone 53 of the assigned user.

In the smartphone 53, the communication unit 76 receives the proximity notification from the vehicle allocation control apparatus 51. Furthermore, in the smartphone 53, in response to the proximity notification, the display control unit 77 causes a proximity message “The taxi is nearby”, which indicates that the assigned taxi is nearby, to be displayed on the map on the display unit 78, as illustrated in FIG. 13. As a result, the user can recognize that the assigned taxi is within the visible range.

In response to the proximity message, the user directs the camera 73 of the smartphone 53 to the autonomous driving taxi 52 in the surrounding visible range and starts to capture an image.

Meanwhile, in the autonomous driving taxi 52 selected as the assigned taxi, the communication unit 65 receives the proximity notification from the vehicle allocation control apparatus 51. In the autonomous driving taxi 52 selected as the assigned taxi, the transmission control unit 63 starts to include the taxi ID of the autonomous driving taxi 52 selected as the assigned taxi in the near-infrared light emitted by the LiDAR 61 and transmit the near-infrared light in response to the proximity notification.

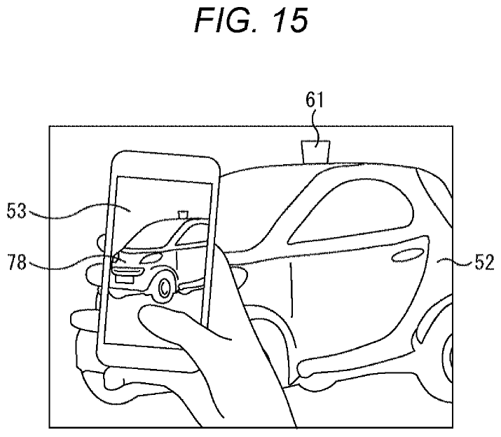

FIG. 14 is a diagram illustrating an example of a state of a road when the user is waiting for the autonomous driving taxi 52 selected as the assigned taxi.

When the taxi service by autonomous driving becomes widespread, it is expected that vehicles of the same vehicle type and color will be adopted as the autonomous driving taxis 52. In this case, as illustrated in FIG. 14, it is expected that a plurality of autonomous driving taxis 52 will travel in the range visible to the user, and it is difficult for the user to recognize the autonomous driving taxi 52 as the assigned taxi assigned to the user from among the plurality of autonomous driving taxis 52 traveling in the visible range.

FIG. 15 is a diagram illustrating a state in which, in response to the proximity message, the user is directing the camera 73 of the smartphone 53 to the autonomous driving taxi 52 in the surrounding visible range to capture an image.

As described with reference to FIG. 13, when moving to the range visible to the assigned user, the autonomous driving taxi 52 selected as the assigned taxi includes the taxi ID in the near-infrared light emitted by the LiDAR 61 and transmits the near-infrared light.

In the smartphone 53, the camera 73 captures an image, and the captured image is displayed (as a live view image) on the display unit 78. In capturing an image, the camera 73 can also receive the near-infrared light emitted by the autonomous driving taxi 52 and including the taxi ID in addition to visible light. In the smartphone 53, the information acquisition unit 71 acquires the taxi ID included in the near-infrared light from the autonomous driving taxi 52 from the light reception signal (image) obtained by the imaging element of the camera 73 receiving the near-infrared light from the autonomous driving taxi 52.

Furthermore, in the smartphone 53, the control unit 80 determines whether or not the acquired ID, which is the taxi ID included in near-infrared light from the autonomous driving taxi 52, matches the taxi ID of the assigned taxi transmitted from the vehicle allocation control apparatus 51, which has been described with reference to FIG. 12.

In a case where the taxi ID included in the near-infrared light from the autonomous driving taxi 52 matches the taxi ID of the assigned taxi, in the smartphone 53, the specification unit 72 specifies the autonomous driving taxi 52 that has transmitted the near-infrared light including the taxi ID matching the assigned taxi ID from among the subjects shown in the image captured by the camera 73 on the basis of the light emission position of the near-infrared light, and recognizes the autonomous driving taxi 52 as the assigned taxi.

Furthermore, in the smartphone 53, the display control unit 77 causes the display unit 78 to display the image captured by the camera 73 and showing the assigned taxi such that the assigned taxi can be identified.

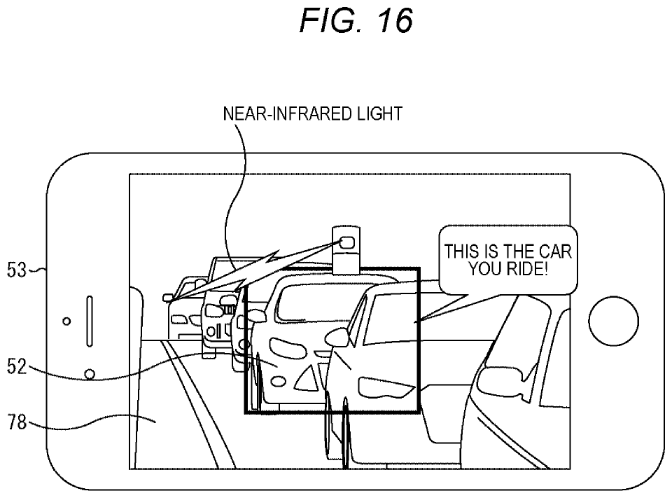

FIG. 16 is a diagram illustrating a display example of the image displayed such that the assigned taxi can be identified.

In FIG. 16, on the display unit 78 of the smartphone 53, a frame surrounding the assigned taxi and a message “This is the car you ride!”, which indicates the assigned taxi, are displayed in the image showing the autonomous driving taxi 52 as the assigned taxi.

The assigned user can easily recognize (the autonomous driving taxi 52 selected as) the assigned taxi by viewing the display on the display unit 78.

Note that, in a case where the autonomous driving taxi 52 as the assigned taxi has deviated from the angle of view of the camera 73 due to, for example, a hand of the user holding the smartphone 53 being shaken, the display control unit 77 can cause the display unit 78 to display a direction in which the autonomous driving taxi 52 as the assigned taxi is present by an arrow or the like, and can prompt the user to capture an image such that the autonomous driving taxi 52 as the assigned taxi is included in the angle of view of the camera 73.

In the smartphone 53, the relative position calculation unit 75 calculates the relative position of the autonomous driving taxi 52 as the assigned taxi with respect to the smartphone 53 using the image captured by the camera 73 and showing the autonomous driving taxi 52 as the assigned taxi, and the communication unit 76 transmits the relative position to the autonomous driving taxi 52 as the assigned taxi via the vehicle allocation control apparatus 51 (or directly).

In the autonomous driving taxi 52 as the assigned taxi, the communication unit 65 receives the relative position with respect to the smartphone 53, and the autonomous driving control unit 62 uses the relative position to obtain the relative position of the user with respect to the current location. The autonomous driving control unit 62 then moves the autonomous driving taxi 52 as the assigned taxi to the vicinity of the user position and stops (stops) the autonomous driving taxi 52 there.

The relative position of the user obtained by use of the relative position of the autonomous driving taxi 52 as the assigned taxi with respect to the smartphone 53 is more accurate than the user position obtained by the GPS or the like, and according to such a highly accurate relative position, the autonomous driving taxi 52 as the assigned taxi can stop, for example, at the position in front of the user, which is extremely close to the user, similarly to a manned taxi.

The autonomous driving taxi 52 as the assigned taxi, which has stopped in the vicinity of the user position, then allows the user to ride and moves to the destination transmitted from the vehicle allocation control apparatus 51.

Note that the calculation of the relative position of the autonomous driving taxi 52 using the image showing the autonomous driving taxi 52 can be performed not only by the smartphone 53 but also by, for example, the vehicle allocation control apparatus 51, the autonomous driving taxi 52, a server on the cloud, which is rich in calculation resources, or the like.

Furthermore, in addition to including the taxi ID in the near-infrared light of the LiDAR 61 and transmitting the near-infrared light, the autonomous driving taxi 52 can display the taxi ID or a QR code (registered trademark) representing the taxi ID such that an image of the taxi ID or the QR code can be captured from the outside of the autonomous driving taxi 52. In this case, the smartphone 53 can acquire the taxi ID by capturing the image of the taxi ID or the QR code displayed on the autonomous driving taxi 52.

Furthermore, as the taxi ID, not only information fixed for the autonomous driving taxi 52 but also a reservation number can be used. The reservation number used as the taxi ID is issued by the vehicle allocation control apparatus 51 for each vehicle allocation request.

Furthermore, as the taxi ID, for example, the number of the license plate of the autonomous driving taxi 52 can be adopted. In this case, the smartphone 53 can acquire the taxi ID by recognizing the number of the license plate of the autonomous driving taxi 52 by an optical character recognition (OCR) technology.

### Embodiment of Vehicle Control System to which Communication System Is Applied

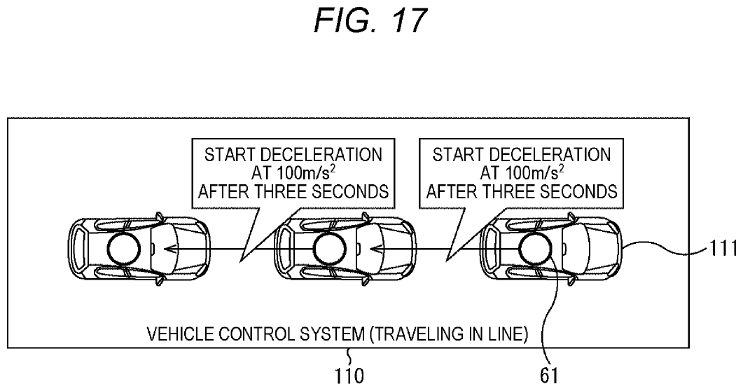

FIG. 17 is a diagram illustrating a configuration example of a first embodiment of a vehicle control system to which the communication system 1 in FIG. 1 is applied.

Here, the communication in which information is included in the near-infrared light emitted by the distance measuring device 11 such as the LiDAR 61 and the near-infrared light is transmitted is also referred to as distance measuring optical communication.

In the distance measuring optical communication, on the light receiving side that receives (can receive) near-infrared light, it is possible to specify the accurate position and direction of the light emitting source of the near-infrared light, that is, the transmission side that includes information in near-infrared light and transmits the near-infrared light.

As described above, the communication system 1 in FIG. 1 can be applied to various systems by use of the characteristics of the distance measuring optical communication in which, on the light receiving side that receives near-infrared light, it is possible to specify the accurate position and direction of the transmission side that includes information in near-infrared light and transmits the near-infrared light.

In FIG. 17, a vehicle control system 110 includes, for example, three autonomous driving vehicles (automobiles) 111 as a plurality of vehicles.

Each of the autonomous driving vehicles 111 corresponds to the mobile body 10 in FIG. 1, is configured similarly to, for example, the autonomous driving taxi 52 in FIG. 3, and further has functions similar to those of the information acquisition unit 71 and the specification unit 72 of the smartphone 53 in FIG. 4.

In the vehicle control system 110 in FIG. 17, each of the autonomous driving vehicles 111 except the first autonomous driving vehicle 111 traveling at the head acquires and shares an operation plan of traveling, such as acceleration, deceleration, or lane change, for example, which is included in near-infrared light of the LiDAR 61 and transmitted from the autonomous driving vehicle 111 traveling immediately in front, so that it is possible to realize traveling in line, which is safe and high-speed cooperative traveling.

In FIG. 17, the autonomous driving control unit 62 of the first autonomous driving vehicle 111 determines an operation of starting deceleration at 100 m/s² after three seconds, includes an operation plan indicating the operation in near-infrared light emitted by the LiDAR 61, and transmits the near-infrared light.

The second autonomous driving vehicle 111 receives near-infrared light emitted by another one of the autonomous driving vehicles 111 with the imaging element of the camera 64 or the light receiving element of the LiDAR 61, and acquires an operation plan included in the near-infrared light, similarly to the information acquisition unit 71 (FIG. 4). Furthermore, similarly to the specification unit 72 (FIG. 4), the second autonomous driving vehicle 111 specifies the autonomous driving vehicle that has transmitted the near-infrared light including the operation plan (hereinafter, the autonomous driving vehicle will also be referred to as a transmission source vehicle). In a case where the autonomous driving vehicle specified as the transmission source vehicle is the first autonomous driving vehicle 111, the second autonomous driving vehicle 111 changes an operation plan of itself (the second autonomous driving vehicle 111) to, for example, the start of deceleration at 100 m/s² after three seconds according to the operation plan transmitted from the first autonomous driving vehicle 111, includes the changed operation plan in near-infrared light emitted by the LiDAR 61, and transmits the near-infrared light.

The third autonomous driving vehicle 111 receives near-infrared light emitted by another one of the autonomous driving vehicles 111 with the imaging element of the camera 64 or the light receiving element of the LiDAR 61, and acquires an operation plan included in the near-infrared light, similarly to the information acquisition unit 71. Furthermore, similarly to the specification unit 72, the third autonomous driving vehicle 111 specifies the transmission source vehicle that has transmitted the near-infrared light including the operation plan. In a case where the autonomous driving vehicle specified as the transmission source vehicle is the second autonomous driving vehicle 111, the third autonomous driving vehicle 111 changes an operation plan of itself (the third autonomous driving vehicle 111) to, for example, the start of deceleration at 100 m/s² after three seconds according to the operation plan transmitted from the second autonomous driving vehicle 111.

Each of the autonomous driving vehicles 111 travels (moves) according to the operation plan, so that the three autonomous driving vehicles 111 travel in line.

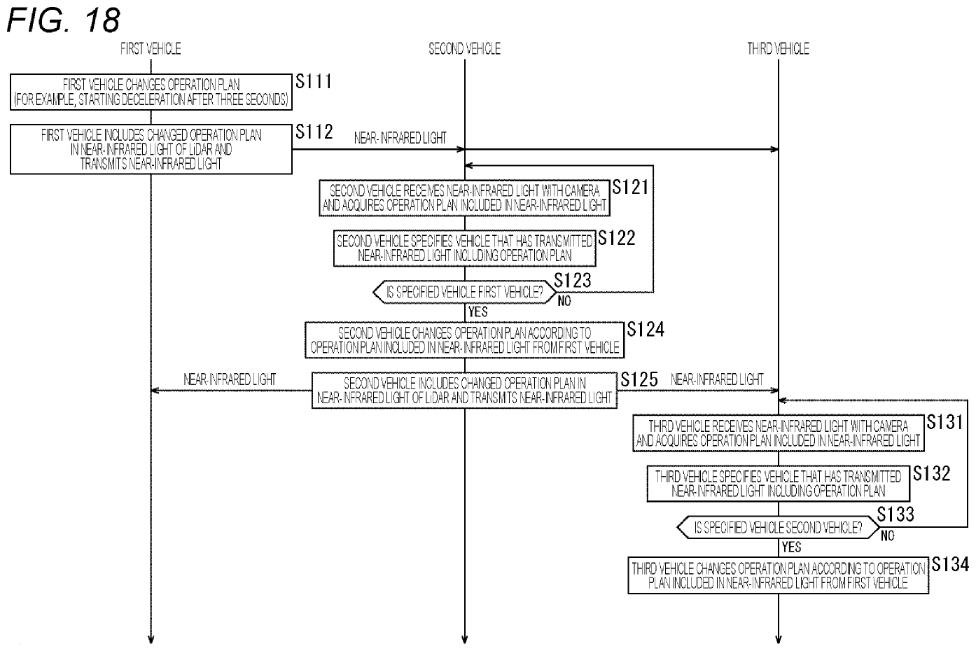

FIG. 18 is a diagram for describing an example of processing in the vehicle control system 110 in FIG. 17.

In step S111, the first autonomous driving vehicle 111 changes the operation plan.

In step S112, the first autonomous driving vehicle 111 includes the changed operation plan in the near-infrared light emitted by the LiDAR 61 and transmits the near-infrared light. The near-infrared light is received by the autonomous driving vehicles 111 surrounding the first autonomous driving vehicle 111.

In step S121, the second autonomous driving vehicle 111 receives near-infrared light emitted by another one of the autonomous driving vehicles 111 with the imaging element of the camera 64 (FIG. 3) or the light receiving element of the LiDAR 61, and acquires an operation plan included in the near-infrared light, similarly to the information acquisition unit 71 (FIG. 4).

In step S122, similarly to the specification unit 72 (FIG. 4), the second autonomous driving vehicle 111 specifies the transmission source vehicle, which is the autonomous driving vehicle that has transmitted the near-infrared light including the operation plan.

In step S123, the second autonomous driving vehicle 111 determines whether or not the autonomous driving vehicle specified as the transmission source vehicle is the first autonomous driving vehicle 111 (the first autonomous driving vehicle 111 immediately in front of the second autonomous driving vehicle 111).

In a case where it is determined in step S123 that the autonomous driving vehicle specified as the transmission source vehicle is not the first autonomous driving vehicle 111, the processing returns to step S121.

Furthermore, in a case where it is determined in step S123 that the autonomous driving vehicle specified as the transmission source vehicle is the first autonomous driving vehicle 111, the processing proceeds to step S124.

In step S124, the second autonomous driving vehicle 111 changes the operation plan of itself (the second autonomous driving vehicle 111) according to the operation plan transmitted from the first autonomous driving vehicle 111.

In step S125, the second autonomous driving vehicle 111 includes the changed operation plan in the near-infrared light emitted by the LiDAR 61 and transmits the near-infrared light. The near-infrared light is received by the autonomous driving vehicles 111 surrounding the second autonomous driving vehicle 111.

In step S131, the third autonomous driving vehicle 111 receives near-infrared light emitted by another one of the autonomous driving vehicles 111 with the imaging element of the camera 64 or the light receiving element of the LiDAR 61, and acquires an operation plan included in the near-infrared light, similarly to the information acquisition unit 71.

In step S132, similarly to the specification unit 72, the third autonomous driving vehicle 111 specifies the transmission source vehicle, which is the autonomous driving vehicle that has transmitted the near-infrared light including the operation plan.

In step S133, the third autonomous driving vehicle 111 determines whether or not the autonomous driving vehicle specified as the transmission source vehicle is the second autonomous driving vehicle 111 (the second autonomous driving vehicle 111 immediately in front of the third autonomous driving vehicle 111).

In a case where it is determined in step S133 that the autonomous driving vehicle specified as the transmission source vehicle is not the second autonomous driving vehicle 111, the processing returns to step S131.

Furthermore, in a case where it is determined in step S133 that the autonomous driving vehicle specified as the transmission source vehicle is the second autonomous driving vehicle 111, the processing proceeds to step S134.

In step S134, the third autonomous driving vehicle 111 changes the operation plan of itself (the third autonomous driving vehicle 111) according to the operation plan transmitted from the second autonomous driving vehicle 111.

Each of the first, second, and third autonomous driving vehicles 111 travels (moves) according to the changed operation plan.

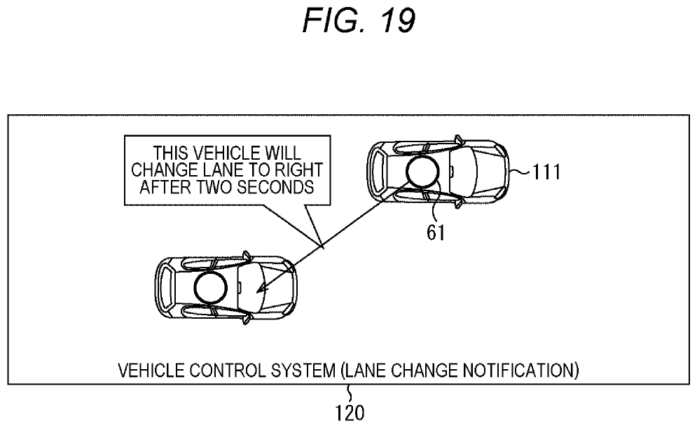

FIG. 19 is a diagram illustrating a configuration example of a second embodiment of the vehicle control system to which the communication system 1 in FIG. 1 is applied.

In FIG. 19, a vehicle control system 120 includes, for example, two autonomous driving vehicles (automobiles) 111 as a plurality of vehicles.

As described with reference to FIG. 17, each of the autonomous driving vehicles 111 corresponds to the mobile body 10 in FIG. 1, is configured similarly to, for example, the autonomous driving taxi 52 in FIG. 3, and further has functions similar to those of the information acquisition unit 71 and the specification unit 72 of the smartphone 53 in FIG. 4.

In the vehicle control system 110 in FIG. 17, the autonomous driving vehicle 111 traveling ahead includes an operation plan in near-infrared light of the LiDAR 61 and transmits the near-infrared light.

The autonomous driving vehicle 111 traveling behind receives the near-infrared light emitted by the autonomous driving vehicle 111 traveling ahead with the imaging element of the camera 64 or the light receiving element of the LiDAR 61, and acquires the operation plan included in the near-infrared light, similarly to the information acquisition unit 71 (FIG. 4). Similarly to the specification unit 72 (FIG. 4), the autonomous driving vehicle 111 traveling behind specifies the transmission source vehicle that has transmitted the near-infrared light including the operation plan. In a case where the autonomous driving vehicle specified as the transmission source vehicle is the autonomous driving vehicle 111 traveling ahead, the autonomous driving vehicle 111 traveling behind changes an operation plan of itself (the autonomous driving vehicle 111 traveling behind) according to the operation plan transmitted from the autonomous driving vehicle 111 traveling ahead.

For example, in a case where the operation plan of the autonomous driving vehicle 111 traveling ahead indicates that the autonomous driving vehicle 111 traveling ahead will change the lane to the right after two seconds, and the autonomous driving vehicle 111 traveling behind is traveling on the right side of and diagonally behind the autonomous driving vehicle 111 traveling ahead, the autonomous driving vehicle 111 traveling behind changes the operation plan so as to decelerate to avoid colliding when the autonomous driving vehicle 111 traveling ahead changes the lane to the right, and decelerates according to the changed operation plan.

The vehicle control system 120 can be applied, for example, in a case where an autonomous driving vehicle to which a specific task is given, such as a truck for carrying a load, and an autonomous driving vehicle as a general vehicle on which a general person rides cooperatively travel.

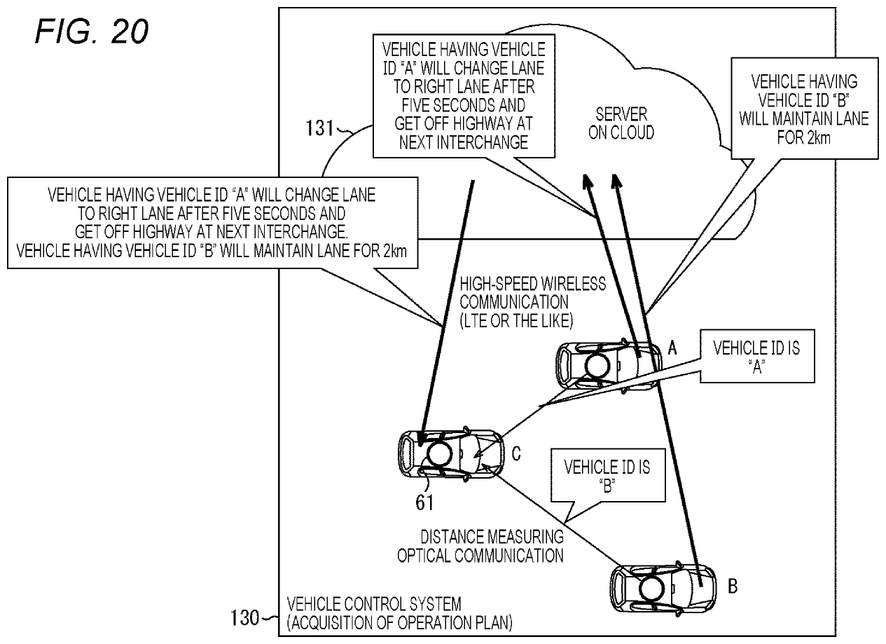

FIG. 20 is a diagram illustrating a configuration example of a third embodiment of the vehicle control system to which the communication system 1 in FIG. 1 is applied.

In FIG. 20, a vehicle control system 130 includes, for example, three autonomous driving vehicles (automobiles) A, B, and C as a plurality of vehicles.

Each of the autonomous driving vehicles A to C corresponds to the mobile body 10 in FIG. 1, is configured similarly to, for example, the autonomous driving taxi 52 in FIG. 3, and further has functions similar to those of the information acquisition unit 71 and the specification unit 72 of the smartphone 53 in FIG. 4.

In the vehicle control system 130 in FIG. 20, distance measuring optical communication is performed in which each of the three autonomous driving vehicles A to C traveling in the vicinity, that is, in a range where near-infrared light reaches, includes, in near-infrared light of the LiDAR 61, a vehicle ID as identification information for identifying each of the three autonomous driving vehicles A to C, and transmits the near-infrared light. Each of the autonomous driving vehicles A to C receives near-infrared light from another autonomous driving vehicle and acquires the vehicle ID included in the near-infrared light. Furthermore, each of the autonomous driving vehicles A to C specifies the transmission source vehicle that has transmitted the near-infrared light including the vehicle ID.

For example, focusing on the autonomous driving vehicle C among the autonomous driving vehicles A to C, the autonomous driving vehicle C receives a beam of near-infrared light from each of the other autonomous driving vehicles A and B, and acquires a vehicle ID=A and a vehicle ID=B included in the beams of near-infrared light. Furthermore, the autonomous driving vehicle C specifies the transmission source vehicles that have transmitted the beam of near-infrared light including the vehicle ID=A and the beam of near-infrared light including the vehicle ID=B.

According to the specification of the transmission source vehicle by the autonomous driving vehicle C, the autonomous driving vehicle C recognizes that the autonomous driving vehicle A traveling on the left front side of the autonomous driving vehicle C is the transmission source vehicle that has transmitted the beam of near-infrared light including the vehicle ID=A. Furthermore, it is recognized that the autonomous driving vehicle B traveling on the right front side of the autonomous driving vehicle C is the transmission source vehicle that has transmitted the beam of near-infrared light including the vehicle ID=A.

In the vehicle control system 130, the communication unit 65 (FIG. 3) of each of the autonomous driving vehicles A to C performs wireless communication such as LTE, 5G, or a wireless LAN, which is faster than the distance measuring optical communication, thereby uploading operation plans to a server 131 on the cloud in association with the vehicle IDs.

The communication unit 65 (FIG. 3) of the autonomous driving vehicle C downloads, from the server 131, the operation plans each associated with one of the vehicle ID=A and the vehicle ID=B included in the beams of near-infrared light by performing wireless communication with the server 131. The autonomous driving vehicle C can recognize that the operation plan associated with the vehicle ID=A is an operation plan of the autonomous driving vehicle A traveling in the left front side, and that the operation plan associated with the vehicle ID=B is an operation plan of the autonomous driving vehicle B traveling in the right front side.

In FIG. 20, as the operation plan of the autonomous driving vehicle A, changing the lane to the right lane after five seconds and getting off the highway at the next interchange are uploaded to the server 131, and as the operation plan of the autonomous driving vehicle B, maintaining the lane for 2 km is uploaded to the server 131. The autonomous driving vehicle C can recognize these operation plans, that is, the operation plan of the autonomous driving vehicle A traveling on the left front side and the operation plan of the autonomous driving vehicle B traveling on the right front side, make an operation plan of the own vehicle according to these operation plans, and perform safe autonomous driving.

The distance measuring optical communication, in which information is included in near-infrared light of the LiDAR 61 and the near-infrared light is transmitted, is low-rate communication, and it takes time to transmit and receive an operation plan by the distance measuring optical communication in a case where the operation plan is large-capacity data. Therefore, in the autonomous driving vehicles, an operation plan as large-capacity data is uploaded to the server 131, which is capable of performing high-speed wireless communication, in association with a vehicle ID, the vehicle ID with a small data amount is acquired by the distance measuring optical communication, and the operation plan associated with the vehicle ID is then downloaded by the high-speed wireless communication, so that it is possible to quickly acquire the operation plan as large-capacity data.

Note that the data uploaded to the server 131 in association with the vehicle ID is not limited to the operation plan.

Furthermore, in the present embodiment, information is transmitted by the distance measuring optical communication, but the information can be transmitted by any other optical communication.

### Description of Computer to which Present Technology Is Applied

Next, all or a part of a series of processing in each of the mobile body 10, the terminal 20, the vehicle allocation control apparatus 51, the autonomous driving taxis 52, the smartphone 53, the autonomous driving vehicles 111, and the autonomous driving vehicles A to C described above can be performed by hardware or software. In a case where the series of processing is performed by software, a program constituting the software is installed in a general-purpose computer or the like.

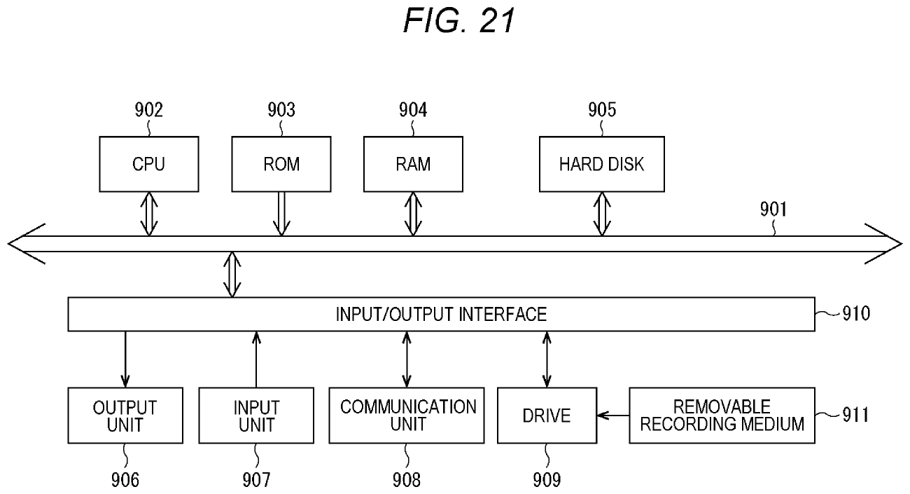

FIG. 21 is a block diagram illustrating a configuration example of an embodiment of a computer on which the program for executing the above-described series of processing is installed.

The program can be recorded in advance on a hard disk 905 or a ROM 903 as a recording medium incorporated in the computer.

Alternatively, the program can be stored (recorded) in a removable recording medium 911 driven by a drive 909. The removable recording medium 911 as described above can be provided as so-called packaged software. Here, examples of the removable recording medium 911 include a flexible disk, a compact disc read only memory (CD-ROM), a magneto optical (MO) disk, a digital versatile disc (DVD), a magnetic disk, a semiconductor memory, and the like.

Note that the program can be installed in the computer from the removable recording medium 911 as described above, or can be downloaded to the computer via a communication network or a broadcasting network and installed in the incorporated hard disk 905. That is, the program can be wirelessly transferred to the computer, for example, from a download site via an artificial satellite for digital satellite broadcasting, or can be transferred by wire to the computer via a network such as a local area network (LAN) or the Internet.

The computer incorporates a central processing unit (CPU) 902, and an input/output interface 910 is connected to the CPU 902 via a bus 901.

When a command is input by a user operating an input unit 907 via the input/output interface 910, for example, the CPU 902 executes the program stored in the read only memory (ROM) 903 according to the command. Alternatively, the CPU 902 loads the program stored in the hard disk 905 into a random access memory (RAM) 904 and executes the program.

As a result, the CPU 902 performs the processing according to the above-described flowcharts or the processing performed by the configurations of the above-described block diagrams. The CPU 902 then outputs, if necessary, a processing result from an output unit 906, transmits the processing result from a communication unit 908, and records the processing result on the hard disk 905, for example, via the input/output interface 910.

Note that the input unit 907 includes a keyboard, a mouse, a microphone, and the like. Furthermore, the output unit 906 includes a liquid crystal display (LCD), a speaker, and the like.

Here, in the present specification, the processing performed by the computer according to the program does not necessarily have to be performed in time series in the orders described as the flowcharts. That is, the processing performed by the computer according to the program also includes processing executed in parallel or individually (for example, parallel processing or processing by an object).

Furthermore, the program may be processed by one computer (processor) or may be distributed to and processed by a plurality of computers. Moreover, the program may be transferred to and executed by a distant computer.

Furthermore, in the present specification, a system means a set of a plurality of components (devices, modules (parts), and the like), and it does not matter whether or not all the components are in the same housing. Therefore, a plurality of devices housed in separate housings and connected via a network and one device in which a plurality of modules is housed in one housing are both systems.

Note that embodiments of the present technology are not limited to the above-described embodiments, and various modifications can be made without departing from the gist of the present technology.

For example, in one of the embodiments described above, the vehicle allocation system has been described by use of the autonomous driving taxis managed by the autonomous driving taxi company that provides the taxi service. However, in addition to the embodiment, the vehicle allocation system may be a platform that provides a taxi service integrating autonomous driving taxis managed by individuals or autonomous driving taxis managed by individuals. Furthermore, the vehicle allocation system may be used not only in the service called taxi service but also in another service called ride-sharing, car-sharing, or the like, which is used by matching a vehicle with a user.

For example, the present technology can have a configuration of cloud computing in which one function is shared and processed in cooperation by a plurality of devices via a network.

Furthermore, each step described in the above-described flowcharts can be executed by one device or shared and executed by a plurality of devices.

Moreover, in a case where one step includes a plurality of sets of processing, the plurality of sets of processing included in the one step can be executed by one device or shared and executed by a plurality of devices.

Furthermore, the effects described in the present specification are merely examples and are not limited, and other effects may be obtained.

Note that the present technology can have the following configurations.

<1>

A mobile body including

a transmission control unit configured to perform control to transmit predetermined information by modulation of light emitted by a distance measuring device that emits the light and receives reflected light of the light for performing distance measurement.

<2>

The mobile body according to <1>,

in which the predetermined information is transmitted by amplitude modulation or frequency modulation of the light being performed.

<3>

The mobile body according to <1>or <2>,

in which the predetermined information is identification information for identifying the mobile body.

<4>

The mobile body according to <3>,

which moves to a vicinity of an information processing device and stops in the vicinity of the information processing device according to a relative position of the mobile body with respect to the information processing device, the relative position being detected from an image captured by an image capturing unit of the information processing device and showing the mobile body, the image capturing unit including an imaging element that receives the light.

<5>

The mobile body according to <1>or <2>,

in which the predetermined information is an operation plan of the mobile body.

<6>

The mobile body according to <5>,

which moves according to an operation plan of another mobile body.

<7>

The mobile body according to <1>or <2>, further including:

an identification information acquisition unit configured to acquire identification information of another mobile body from a light reception signal obtained by reception of light from the another mobile body; and

a specification unit configured to specify the another mobile body that has emitted the light including the identification information,

in which information associated with the identification information of the another mobile body specified by the specification unit is received.

<8>

The mobile body according to <7>,

which travels in line together with the another mobile body on the basis of an operation plan of the another mobile body.

<9>

The mobile body according to any one of <1>to <8>,

which is a vehicle.

<10>

The mobile body according to <9>,

which is a taxi used by a predetermined user.

<11>

The mobile body according to any one of <1>to <10>,

in which the light is near-infrared light.

<12>

The mobile body according to <11>,

in which the light is near-infrared light emitted by a LiDAR.

<13>

An information processing device including:

an information acquisition unit configured to acquire, from a light reception signal obtained by reception of light emitted by a distance measuring device that emits the light and receives reflected light of the light for performing distance measurement, predetermined information transmitted by modulation of the light and including at least identification information for identifying a mobile body including the distance measuring device; and

a specification unit configured to specify the mobile body including the distance measuring device that has emitted the light including the predetermined information.

<14>

The information processing device according to <13>,

which is used by a user, and further includes a display control unit configured to perform control to display the mobile body specified by the specification unit, the mobile body being capable of being visually identified by the user.

<15>

The information processing device according to <13>or <14>,

further including an image capturing unit,

in which the specification unit specifies the mobile body including the distance measuring device that has emitted the light including the predetermined information from an image captured by the image capturing unit and showing the mobile body.

<16>

The information processing device according to <15>,

further including a relative position calculation unit configured to calculate a relative position of the mobile body with respect to the information processing device from the image captured by the image capturing unit and showing the mobile body,

in which the relative position is transmitted to the mobile body.

<17>

The information processing device according to any one of <13>to <16>,

in which the mobile body is a vehicle.

<18>

The information processing device according to <17>,

in which the mobile body is a taxi used by a predetermined user.

<19>

The information processing device according to any one of <13>to <18>,

in which the light is near-infrared light.

<20>

The information processing device according to <19>,

in which the light is near-infrared light emitted by a LiDAR.

<21>

An information processing system including:

a mobile body including a transmission control unit configured to perform control to transmit predetermined information by modulation of light emitted by a distance measuring device that emits the light and receives reflected light of the light for performing distance measurement; and

an information processing device including

an information acquisition unit configured to acquire, from a light reception signal obtained by reception of the light, the predetermined information transmitted by modulation of the light, and

a specification unit configured to specify the mobile body including the distance measuring device that has emitted the light including the predetermined information.

<22>

The information processing system according to <21>,

in which the mobile body is a taxi,

the information processing device is a terminal device used by a user who uses the taxi, or an information processing device provided in the terminal device, and

the predetermined information includes at least information for identifying the taxi.

<23>

The information processing system according to <22>,

in which the information processing device further includes a display control unit configured to perform control to display the mobile body specified by the specification unit, the mobile body being capable of being visually identified by the user.

<24>

The information processing system according to any one of <21>to <23>,

in which the information processing device further includes an image capturing unit, and

the specification unit specifies the mobile body including the distance measuring device that has emitted the light including the predetermined information from an image captured by the image capturing unit and showing the mobile body.

<25>

The information processing system according to <24>,

in which the information processing device further includes a relative position calculation unit configured to calculate a relative position of the mobile body with respect to the information processing device from the image captured by the image capturing unit and showing the mobile body, and

the relative position is transmitted to the mobile body.

<26>

The information processing system according to <24>or <25>,

in which the mobile body moves to a vicinity of the information processing device and stops in the vicinity of the information processing device according to a relative position of the mobile body with respect to the information processing device, the relative position being detected from the image captured by the image capturing unit of the information processing device and showing the mobile body, the image capturing unit including an imaging element that receives the light.

### REFERENCE SIGNS LIST

1 Communication system

10 Mobile body

11 Distance measuring device

12 Movement control unit

13 Transmission control unit

20 Terminal

21 Information acquisition unit

22 Specification unit

50 Vehicle allocation system

51 Vehicle allocation control apparatus

52 Autonomous driving taxi

53 Smartphone

61 LiDAR

62 Autonomous driving control unit

63 Transmission control unit

64 Camera

65 Communication unit Position detection unit

71 Information acquisition unit

72 Specification unit

73 Camera

74 Position detection unit

75 Relative position calculation unit

76 Communication unit

77 Display control unit

78 Display unit

79 Operation unit

80 Control unit

110 Vehicle control system

111 Autonomous driving vehicle

120, 130 Vehicle control system

901 Bus

902 CPU

903 ROM

904 RAM

905 Hard disk

906 Output unit

907 Input unit

908 Communication unit

909 Drive

910 Input/output interface

911 Removable recording medium

1. A mobile body comprising
a transmission control unit configured to perform control to transmit predetermined information by modulation of light emitted by a distance measuring device that emits the light and receives reflected light of the light for performing distance measurement.

2. The mobile body according to claim 1,
wherein the predetermined information is transmitted by amplitude modulation or frequency modulation of the light being performed.

3. The mobile body according to claim 1,
wherein the predetermined information is identification information for identifying the mobile body.

4. The mobile body according to claim 3,
which moves to a vicinity of an information processing device and stops in the vicinity of the information processing device according to a relative position of the mobile body with respect to the information processing device, the relative position being detected from an image captured by an image capturing unit of the information processing device and showing the mobile body, the image capturing unit including an imaging element that receives the light.

5. The mobile body according to claim 1,
wherein the predetermined information is an operation plan of the mobile body.

6. The mobile body according to claim 5,
which moves according to an operation plan of another mobile body.

7. The mobile body according to claim 1, further comprising:
an identification information acquisition unit configured to acquire identification information of another mobile body from a light reception signal obtained by reception of light from the another mobile body; and
a specification unit configured to specify the another mobile body that has emitted the light including the identification information,
wherein information associated with the identification information of the another mobile body specified by the specification unit is received.

8. The mobile body according to claim 7,
which travels in line together with the another mobile body on a basis of an operation plan of the another mobile body.

9. The mobile body according to claim 1,
which is a vehicle.

10. The mobile body according to claim 9,
which is a taxi used by a predetermined user.

11. The mobile body according to claim 1,
wherein the light is near-infrared light.

12. The mobile body according to claim 11,
wherein the light is near-infrared light emitted by a LiDAR.

13. An information processing device comprising:
an information acquisition unit configured to acquire, from a light reception signal obtained by reception of light emitted by a distance measuring device that emits the light and receives reflected light of the light for performing distance measurement, predetermined information transmitted by modulation of the light and including at least identification information for identifying a mobile body including the distance measuring device; and
a specification unit configured to specify the mobile body including the distance measuring device that has emitted the light including the predetermined information.

14. The information processing device according to claim 13,
which is used by a user, and further comprises a display control unit configured to perform control to display the mobile body specified by the specification unit, the mobile body being capable of being visually identified by the user.

15. The information processing device according to claim 13,
further comprising an image capturing unit,
wherein the specification unit specifies the mobile body including the distance measuring device that has emitted the light including the predetermined information from an image captured by the image capturing unit and showing the mobile body.

16. The information processing device according to claim 15,
further comprising a relative position calculation unit configured to calculate a relative position of the mobile body with respect to the information processing device from the image captured by the image capturing unit and showing the mobile body,
wherein the relative position is transmitted to the mobile body.

17. The information processing device according to claim 13,
wherein the mobile body is a vehicle.

18. The information processing device according to claim 17,
wherein the mobile body is a taxi used by a predetermined user.

19. The information processing device according to claim 13,
wherein the light is near-infrared light.

20. The information processing device according to claim 19,
wherein the light is near-infrared light emitted by a LiDAR.

21. An information processing system comprising:
a mobile body including a transmission control unit configured to perform control to transmit predetermined information by modulation of light emitted by a distance measuring device that emits the light and receives reflected light of the light for performing distance measurement; and
an information processing device including
an information acquisition unit configured to acquire, from a light reception signal obtained by reception of the light, the predetermined information transmitted by modulation of the light, and
a specification unit configured to specify the mobile body including the distance measuring device that has emitted the light including the predetermined information.

22. The information processing system according to claim 21,
wherein the mobile body is a taxi,
the information processing device is a terminal device used by a user who uses the taxi, or an information processing device provided in the terminal device, and
the predetermined information includes at least information for identifying the taxi.

23. The information processing system according to claim 22,
wherein the information processing device further includes a display control unit configured to perform control to display the mobile body specified by the specification unit, the mobile body being capable of being visually identified by the user.

24. The information processing system according to claim 21,
wherein the information processing device further includes an image capturing unit, and
the specification unit specifies the mobile body including the distance measuring device that has emitted the light including the predetermined information from an image captured by the image capturing unit and showing the mobile body.

25. The information processing system according to claim 24,
wherein the information processing device further includes a relative position calculation unit configured to calculate a relative position of the mobile body with respect to the information processing device from the image captured by the image capturing unit and showing the mobile body, and
the relative position is transmitted to the mobile body.

26. The information processing system according to claim 24,
wherein the mobile body moves to a vicinity of the information processing device and stops in the vicinity of the information processing device according to a relative position of the mobile body with respect to the information processing device, the relative position being detected from the image captured by the image capturing unit of the information processing device and showing the mobile body, the image capturing unit including an imaging element that receives the light.
